(19) United States
(12) Patent Application Publication
(10) Pub. No.: US 2015/0032566 A1
(43) Pub. Date: Jan. 29, 2015

(54) PROVIDING COUNTRY-SPECIFIC RECOMMENDATIONS

(71) Applicant: eBay Inc., San Jose, CA (US)

(72) Inventor: Yoram Vardi, Sunnyvale, CA (US)

(21) Appl. No.: 14/109,797

(22) Filed: Dec. 17, 2013

Related U.S. Application Data
(60) Provisional application No. 61/857,614, filed on Jul. 23, 2013.

(51) Int. Cl. G06Q 30/06

(52) U.S. Cl. CPC G06Q 30/0631
USPC 705/26.7

(57) ABSTRACT

Providing country-specific recommendations for selling an item including detecting the listing of an item that is being listed for sale by a seller in a first country. Responsive to the detecting, determining information to be added to the listing in respect of a possible sale of the item in a second country, and informing the seller of the determined information. The determined information may be obtained using a data analytics method that works on one or more historical data logs to mine information relating to factors that may aid or improve sale of the item in the second country. The determined information may also be determined using a data analytics method that works on one or more historical data logs to mine information that indicates that it is attractive to list the item for sale in the second country.

### RELATED APPLICATION

The present application is related to U.S. application Ser. No. 61/857,614 entitled SYSTEM METHOD FOR PROVIDING CROSS-BORDER TRANSACTION BYUYING ASSISTANT, filed Jul. 23, 2013 which is incorporated herein by reference in its entirety.

### FIELD

The present disclosure relates generally to online shopping and, in a specific example embodiment, to providing county-specific recommendations in selling transactions.

### BACKGROUND

Presently, cross-border trade or transaction (CBT) is increasingly recognized as an important channel for driving growth in ecommerce outside of the domestic (U.S.) market. Among problems found in CBT is that U.S. sellers may not understand how a listing may be tailored so as to better position an item for locations outside the U.S. where the item is likely to sell.

### BRIEF DESCRIPTION OF DRAWINGS

Various ones of the appended drawings merely illustrate example embodiments of the present invention and cannot be considered as limiting its scope.

FIG. 1 is a block diagram illustrating an example embodiment of a network architecture of a system used to provide country-specific recommendations for transaction selling assistance.

FIG. 2 is a block diagram illustrating an example embodiment of a publication system.

FIG. 3 is a diagram illustrating an example of CSR-aided CBT transaction listing flow.

FIG. 4 is a flowchart illustrating an example country-specific recommendation selling listing flow.

FIG. 5 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for providing cross-border trade or transactions with. country-specific recommendation (“CSR”) selling assistance. As one example, the seller may lack knowledge of localized content that may help an item sell well in countries other than the country in which a seller is operating (the other countries sometimes referred to as “foreign countries”), whether with product information, merchandising collaterals, or service materials. Consequently, country-specific recommendations (CSR) providing such information may be important to improving CBT.

In some embodiments, the system may determine what sells well, or best, in foreign countries, and provide an expanded selling profile that may improve the listing process by giving sellers guidance about what foreign countries to sell products in, and what features of item listings (sometimes referred to as “selling factors” or “selling features” or “listing features”) may enable the item to sell well in those countries. This may provide sellers with knowledge of how the listing may be tailored so as to better position the item for foreign locations where the item is more likely to sell.

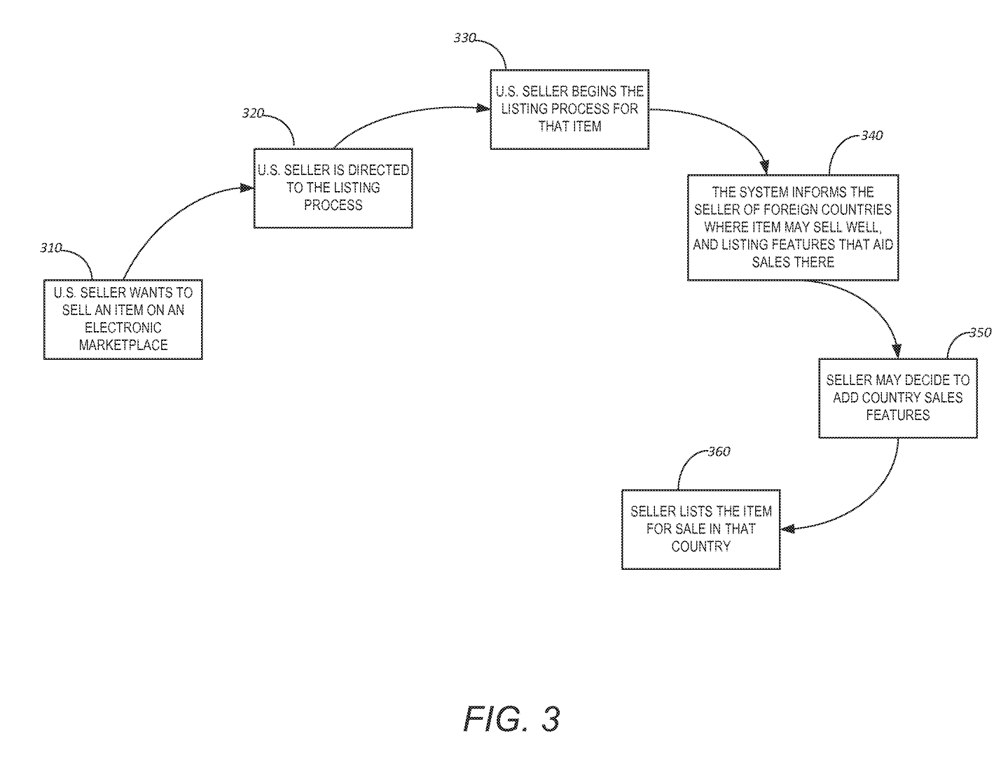

In one embodiment, when a seller lists an item, in addition to the usual item details being entered in the listing process for the local country, the system may be able to suggest additional countries in which to offer the item for sale, and sales factors to add to the listing that may improve sales in those additional countries. This may be accomplished using information more historical data logs to mine information relating to factors that may aid or improve sales in foreign countries. The mined information may also be information that may be attractive if the item is listed for sale in additional countries, such as possibly fetching a higher sales price. An example of data analytics technology is seen in U.S. application Ser. No. 13/492, 116 entitled SYSTEM METHOD FOR MINING CATEGORY ASPECT INFORMATION, filed Jun. 8, 2012 which is incorporated herein by reference in its entirety. The written description of the foregoing patent application is set forth in terms of mining category aspect information. However, the historical data set may comprise other features, such as various factors described below relating to sales of the item in foreign countries. For example, category engine 312 of FIG. 3 of that application, that manages mining for category aspect information, may instead be a country-specific sales feature engine. While that category engine 312 may determine the most relevant category aspects (e.g., aspect name/value pairs) for each category, that engine may, however, instead be implemented to determine the most relevant country-specific selling features for use in the instant patent application. For example, the aspect determination module 408 of that application determines relevant aspect information based on the aspect demand scores. However, module 408 may also be implemented to determine relevant country-specific sales information. The data mining operation may be performed offline and the results stored in a database such as 126 for subsequent use when a seller is listing an item for sale.

In one embodiment, when the seller is listing an item, the system, using the above mined data, may suggest foreign locations in which the particular item being listed is selling well, or locations in which this item will fetch a higher final price than in the local marketplace. Additional such sales factors of foreign locations or foreign countries may include, without limitation:
1. Show the seller that buyers from particular countries generally give a high feedback score than in the local country, or in other countries;
2. Show the seller that in a certain percentage of the cases, items arrive from the local country to the customer in a foreign country within a particular number of days, which may be desirable;
3. Suggest better wording of the title/description that will help sell the item in a particular foreign country; and
4. Suggest translations, which may be fee based, to help the item sell better in those countries.
5. Suggest shipping consideration such as shipping issues for a given country so that the seller can consider shipping for that country.
   With the above information, the seller may continue to finalize listing using the information that may be relevant to the country in which the item will be offered for sale.

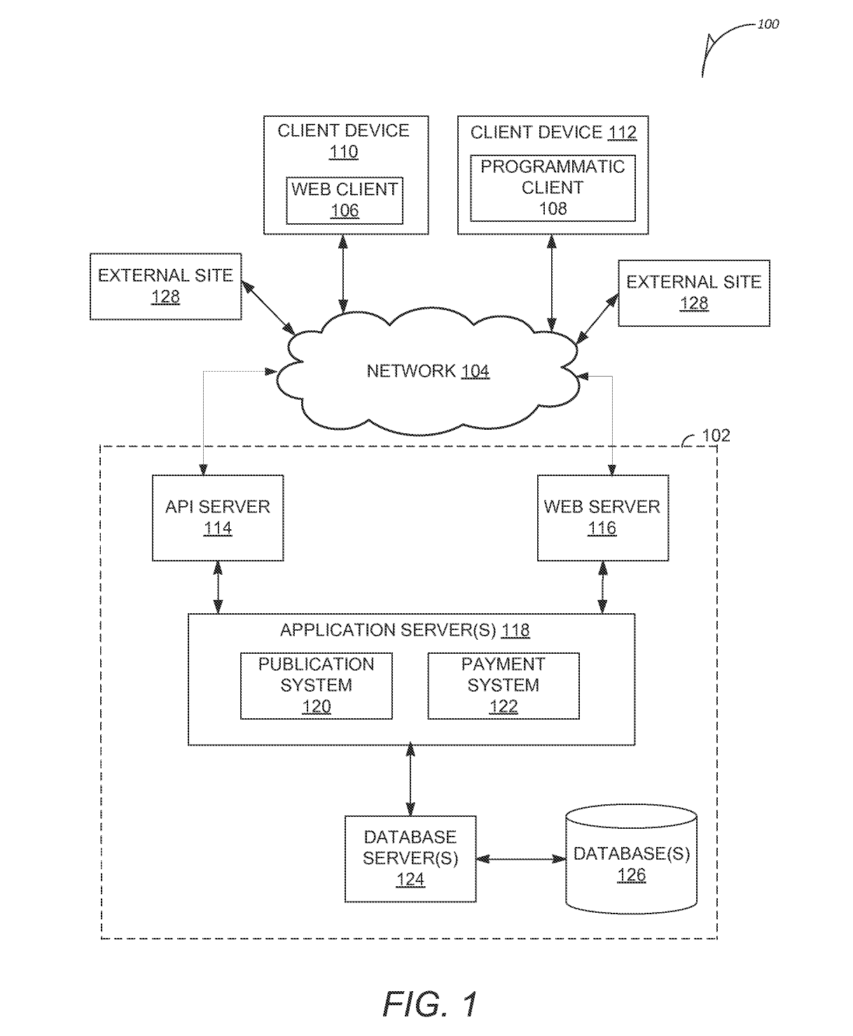

With reference to FIG. 1, an example embodiment of a high-level client-server-based network architecture 100 to enable personalization of search results is shown. A networked system 102, in an example form of a network-server-side functionality, is coupled via a communication network 104 (e.g., the Internet, wireless network, cellular network, or a Wide Area Network (WAN)) to one or more client devices 110 and 112. FIG. 1 illustrates, for example, a web client 106 operating via a browser (e.g., such as the INTERNET EXPLORER® browser developed by Microsoft® Corporation of Redmond, Washington State), and a programmatic client 108 executing on respective client devices 110 and 112.

The client devices 110 and 112 may comprise a mobile phone, desktop computer, laptop, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screen, accelerometer, camera, microphone, and GPS device. The client devices 110 and 112 may be a device of a user, which is used to perform a transaction involving digital goods within the networked system 102. In one embodiment, the networked system 102 is a network-based marketplace that manages digital goods, publishes publications comprising item listings of products available on the network-based marketplace, and manages payments for these marketplace transactions.

An Application Program Interface (API) server 114 and a web server 116 are coupled to, and provide programmatic and web interfaces respectively to, one or more application servers 118. The application servers 118 host a publication system 120 and a payment system 122, each of which may comprise one or more modules, applications, or engines, and each of which may be embodied as hardware, software, firmware, or any combination thereof. The application servers 118 are, in turn, coupled to one or more database servers 124 facilitating access to one or more information storage repositories or database(s) 126. In one embodiment, the databases 126 are storage devices that store information to be posted (e.g., publications or listings) to the publication system 120. The databases 126 may also store digital goods information in accordance with example embodiments.

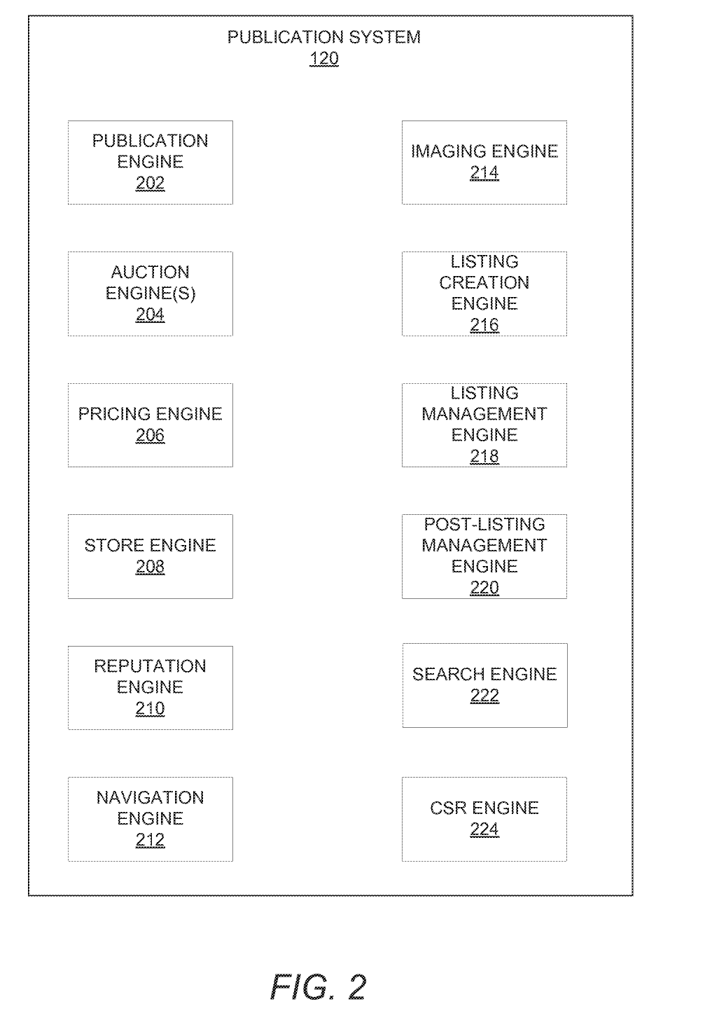

In example embodiments, the publication system 120 publishes content on a network (e.g., Internet). As such, the publication system 120 provides a number of publication and marketplace functions and services to users that access the networked system 102. The publication system. 120 is discussed in more detail in connection with FIG. 2. In example embodiments, the publication system 120 is discussed in terms of an online marketplace environment. However, it is noted that the publication system 120 may be associated with a non-marketplace environment such as an informational (e.g., search engine) or social networking environment.

The payment system 122 provides a number of payment services and functions to users. The payment system 122 allows users to accumulate value (e.g., in a commercial currency, such as the U.S. dollar, or a proprietary currency, such as points, miles, or other forms of currency provide by a private entity) in their accounts, and then later to redeem the accumulated value for products (e.g., goods or services) that are made available via the publication system 120 or elsewhere on the network 104. The payment system 122 also facilitates payments from a payment mechanism (e.g., a bank account, PayPal™, or credit card) for purchases of items via any type and form of a network.-based marketplace.

While the publication system 120 and the payment system 122 are shown in FIG. 1 to both form part of the networked system 102, it will be appreciated that, in alternative embodiments, the payment system 122 may form part of a payment service that is separate and distinct from the networked system 102. Additionally, while the example network architecture 100 of FIG. 1 employs a client-server architecture, a skilled artisan will recognize that the present disclosure is not limited to such an architecture. The example network architecture 100 can equally well find application in, for example, a distributed or peer-to-peer architecture system. The publication system 120 and payment system 122 may also be implemented as standalone systems or standalone software programs operating under separate hardware platforms, which do not necessarily have networking capabilities.

Referring now to FIG. 2, an example block diagram illustrating multiple components that, in one embodiment, are provided within the publication system 120 of the networked system 102 is shown. In this embodiment, the publication system 120 is a marketplace system where items (e.g., goods or services) may be offered for sale. The items may comprise digital goods (e.g., currency, license rights). The publication system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more databases 126 via the one or more database servers 124.

The publication system 120 provides a number of publishing, listing, and price-setting mechanisms whereby a buyer may list (or publish information concerning) goods or services for sale, a buyer can express interest in or indicate a desire to purchase such goods or services, and a price can be set for a transaction pertaining to the goods or services. To this end, the publication system 120 may comprise at least one publication engine 202 and one or more auction engines 204 that support auction-format listing and price setting mechanisms (e.g., English, Dutch, Chinese, Double, Reverse auctions, etc.).

A pricing engine 206 supports various price listing formats. One such format is a fixed-price listing format (e.g., the traditional classified advertisement-type listing or a catalog listing). Another format comprises a buyout-type listing. Buyout-type listings (e.g., the Buy-It-Now (BIN) technology developed by eBay Inc., of San Jose, Calif.) may be offered in conjunction with auction-format listings and allow a buyer to purchase goods or services, which are also being offered for sale via an auction, for a fixed price that is typically higher than a starting price of an auction for an item.

A store engine 208 allows a buyer to group listings within a “virtual” store, which may be branded and otherwise personalized by and for the buyer. Such a virtual store may also offer promotions, incentives, and features that are specific and personalized to the buyer. In one example, the buyer may offer a plurality of items as Buy-It-Now items in the virtual store, offer a plurality of items for auction, or a combination of both.

A reputation engine 210 allows users that transact, utilizing the networked system 102, to establish, build, and maintain reputations. These reputations may be made available and published to potential trading partners. Because the publication system 120 supports person-to-person trading between unknown entities, in accordance with one embodiment, users may otherwise have no history or other reference information whereby the trustworthiness and credibility of potential trading partners may be assessed. The reputation engine 210 allows a user, for example through feedback provided by one or more other transaction partners, to establish a reputation within the network-based marketplace over time. Other potential trading partners may then reference the reputation for purposes of assessing credibility and trustworthiness.

Navigation of the network-based marketplace may be facilitated by a navigation engine 212. For example, a browse module (not shown) of the navigation engine 212 allows users to browse various category, catalog, or inventory data structures according to which listings may be classified within the publication system 120. Various other navigation applications within the navigation engine 212 may be provided to supplement the browsing applications.

In order to make listings available via the networked system 102 as visually informing and attractive as possible, the publication system 120 may includ.e an imaging engine 214 that enables users to upload images for inclusion within publications and to incorporate images within viewed listings. The imaging engine 214 may also receive image data from a user as a search query and utilize the image data to identify an item depicted or described by the image data.

A listing creation engine 216 allows users (e.g., buyers) to conveniently author listings of items. In one embodiment, the listings pertain to goods or services that a user (e.g., a buyer) wishes to transact via the publication system 120. In other embodiments, a user may create a listing that is an advertisement or other form of publication.

A listing management engine 218 allows the users to manage such listings. Specifically, where a particular user has authored or published a large number of listings, the management of such listings may present a challenge. The listing management engine 218 provides a number of features (e.g., auto-relisting, inventory level monitors, etc.) to assist the user in managing such listings.

A post-listing management engine 220 also assists users with a number of activities that typically occur post-listing. For example, upon completion of a transaction facilitated by the one or more auction engines 204, a buyer may wish to leave feedback regarding a particular buyer. To this end, the post-listing management engine 220 provides an interface to the reputation engine 210 allowing the buyer to conveniently provide feedback regarding multiple buyers to the reputation engine 210. Another post-listing action may be shipping of sold items Whereby the post-listing management engine 220 may assist in printing shipping labels, estimating shipping costs, and suggesting shipping carriers.

A search engine 222 performs searches for publications in the networked system 102 that match a query. In example embodiments, the search engine 222 comprises a search module (not shown) that enables keyword searches of publications published via the publication system 120. In a further embodiment, the search engine 222 may take an image received by the imaging engine 214 as an input for conducting a search. The search engine 222 takes the query input and determines a plurality of matches from the networked system 102 (e.g., publications stored in the database 126). It is noted that the functions of the search engine 222 may be combined with the navigation engine 212.

A country-specific recommendation (CSR) engine 224 in FIG. 2 manages cross-border recommendations for transactions in the networked system 102. The operations of the CSR engine 224 will be discussed in more detail below.

Although the various components of the publication system 120 have been defined in terms of a variety of individual modules and engines, a skilled artisan will recognize that many of the items can be combined or organized in other ways and that not all modules or engines need to be present or implemented in accordance with example embodiments. Furthermore, not all components of the marketplace system 120 have been included in FIG. 2. In general, components, protocols, structures, and techniques not directly related to functions of exemplary embodiments (e.g., dispute resolution engine, loyalty promotion engine, personalization engines, etc.) have not been shown or discussed in detail. The description given herein simply provides a variety of exemplary embodiments to aid the reader in an understanding of the systems and methods used herein.

Example embodiments address the implementing CSR. The use of the CSR may enhance the shopping experience of an overseas buyer when purchasing from a domestic buyer on a U.S.-based online market. For example, a China buyer may purchase an item from U.S.-based eBay.com if the item listing includes features that are important to a China buyer. Sellers may implement the country-specific recommendations and not have to alter their sales practice materially, yet can gain additional customers with little or no incremental cost. For example such features may include data relating to item sale at the time of purchase, country of sale, feedback data by country, shipping time from purchase to delivery of the item, shipping issues, price for the particular item per country sold, and packaging preferences. In one embodiment, CSR may present the seller with the countries where the item sells well, the countries ranked, for example, top to bottom., so that the seller can decide whether to list the item for a particular country. In one embodiment, the CSR engine may determine, and the system may present to the listing seller, with the following data by country: price range that sells best to show the seller Where that item can fetch the most, or additional, money in a sale, and what type of listing works best (for example, what do the buyers prefer to see in those countries in terms of fabric types, colors, and the like). Features that may be determined and presented to the seller also include packaging that sells best in various countries, countries with few or no shipping issues, preferred time of arrival, time period from shipment to arrival, and countries where feedback for the item is most favorable. The seller can then decide on the country or countries in which to offer the item for sale and add to the listing the sales features that are favored by that country or those countries, such as price, packaging, fabric, and the other sales features mentioned above, among other features that one of ordinary skill in the art will see as alternate embodiments.

FIG. 3 is a diagram illustrating an example of CSR-aided CBT transaction listing flow. In the embodiment of FIG. 3, listing an item for sale on a U.S. marketplace is shown, the listing having added to it sales factors based on CSR that are attractive to countries outside the U.S. Those of ordinary skill in the art will recognize that the U.S. is used as the local country merely as an example. The diagram may apply to items being listed on a marketplace of any country as the local country. A scenario of the CSR transaction flow assumes that certain sales features listed in an item listing from a U.S.-based online marketplace (e.g., eBay) may enhance sales in a marketplace outside the U.S. The terms “trading” and “transaction” may be used interchangeably. Further, those of ordinary skill in the art will recognize that although steps are provided below in numerical order, the steps below may be performed in any order that will reach the result desired. Those of ordinary skill in the art will recognize that the steps in FIG. 3 need not be performed in the precise order in which they are listed in the figure but, instead, may be used in various orders to implement the process described in the drawing.

Continuing with FIG. 3, at 310 a U.S. seller desires to sell an item on a local electronic marketplace. At 320 the seller is directed to the listing process for listing the item, this may be TurboLister discussed above. At 330 the seller begins the listing process for the item the seller desires to sell. At this point or thereafter, the system may detect that an item is being listed for sale. At 340, using the data mined from the data mining technology described above, such as in the referenced patent application, the system may determine country-specific recommendations for the item being listed for sale, and may inform the seller of foreign countries where the item may sell well, and listing features that may aid, improve, or be attractive with respect to, sales in those foreign countries. The term “listing features” is used broadly and may include information informing the user that a better price might be fetched in a foreign country or that better feedback is received in a foreign country, and the like, which are not actually listing features per se. At 350 the seller may decide to add, or in fact does add, some or all of the foreign country sales features. At 360, may list the item for sale in those foreign countries. Alternatively at 360, the system may detect that the seller intends to list the item for sale in one or more foreign countries (in one embodiment, by detecting a signal indicating that the item is to be listed in the one or more foreign countries) and, responsive to such detecting, carries out the process of listing the item for sale in the one or more foreign countries.

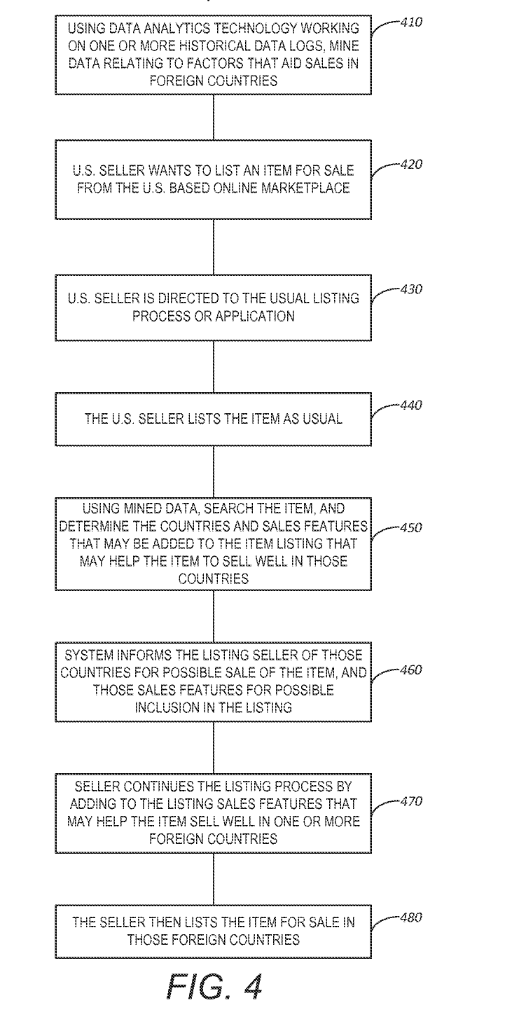

FIG. 4 is a flowchart illustrating an example country-specific recommendation selling listing flow. As with FIG. 3, those of ordinary skill in the art will recognize that the steps in FIG. 4 need not be performed in the precise order in which they are listed in the figure but, instead, may be used in various orders to implement the process described in the flowchart. At 410, using data analytics technology working on one or more historical data logs, the system may mine data relating to factors that aid sales in foreign countries. This may be done offline as discussed above. At 420, the U.S. (or other local country) seller wants to list an item for sale from the U.S.-based online marketplace. At 430 the U.S. seller is directed to the usual listing process or application. At 440, the U.S. seller lists the item as usual. At 450, using mined data, which may have previously been mined offline as discussed above, the system may search the item to be sold and determine the countries and sales features that may be added to the item listing that that may help the item to sell well in those countries. At 460, the system may inform the listing seller of those countries for possible sale of the item, and those sales features for possible inclusion in the listing. At 470 the seller may continue the listing process by adding to the listing one or more of those sales features that may help the item sell well in one or more of those foreign countries. At 480 the seller may list the item for sale in those foreign countries

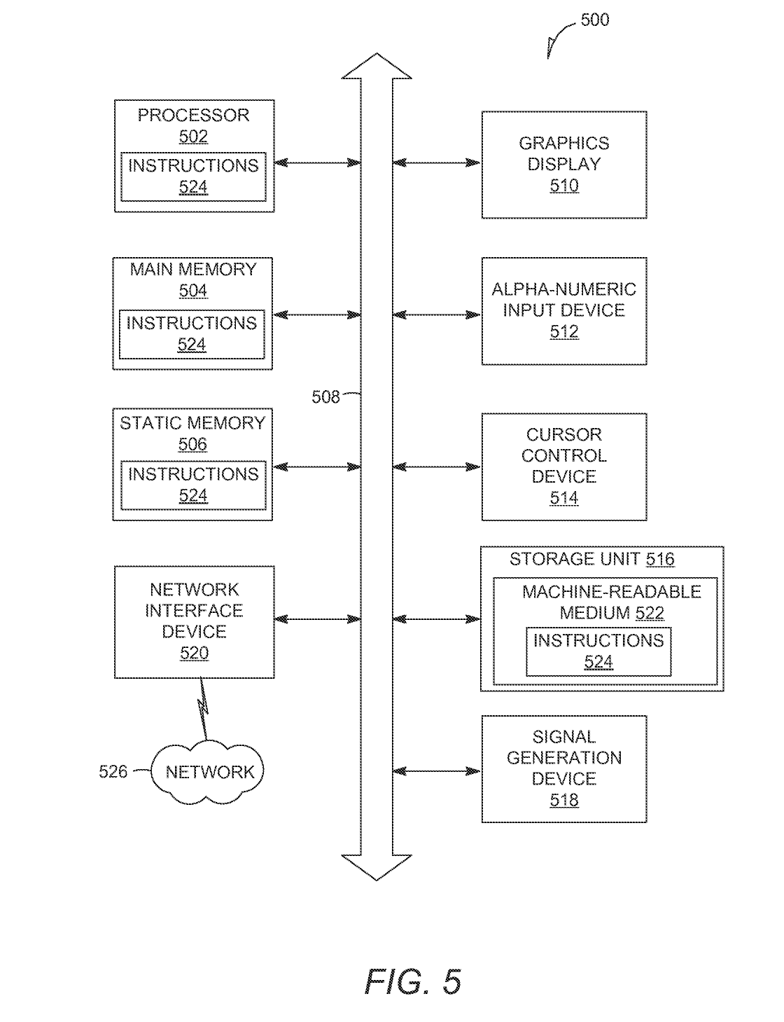

FIG. 5 is a block diagram illustrating components of a machine 500, according to some example embodiments, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system and within which instructions 524 (e.g., software, a program, an application, an applet, an app, or other executable code) for causing the machine 500 to perform any one or more of the methodologies discussed herein may be executed. In alternative embodiments, the machine 500 operates as a standalone device or may be connected (e.g., networked) to other machines. In a networked deployment, the machine 500 may operate in the capacity of a server machine or a client machine in a server-client network environment, or as a peer machine in a peer-to-peer (or distributed) network environment. The machine 500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 524, sequentially or otherwise, that specify actions to be taken by that machine. Further, while only a single machine is illustrated, the term “machine” shall also be taken to include a collection of machines that individually or jointly execute the instructions 524 to perform any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The machine 500 may further include a graphics display 510 (e.g., a plasma display panel (PDP), a light emitting diode (LED) display, a liquid crystal display (LCD), a projector, or a cathode ray tube (CRT)). The machine 500 may also include an alpha-numeric input device 512 (e.g., a keyboard), a cursor control device 514 (e.g., a mouse, a touchpad, a trackball, a joystick, a motion sensor, or other pointing instrument), a storage unit 516, a signal generation device 518 (e.g., a speaker), and a network interface device 520.

The storage unit 516 includes a machine-readable medium 522 on which is stored the instructions 524 embodying any one or more of the methodologies or functions described herein. The instructions 524 may also reside, completely or at least partially, within the main memory 504, within the processor 502 (e.g., within the processor's cache memory), or both, during execution thereof by the machine 500. Accordingly, the main memory 504 and the processor 502 may be considered as machine-readable media. The instructions 524 may be transmitted or received over a network 526 via the network interface device 520.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 500), such that the instructions, when executed by one or more processors of the machine (e.g., processor 502), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium.” shall accordingly be taken to include, but not be limited to, one or more data repositories in the form of a solid-state memory, an optical medium, a magnetic medium, or any suitable combination thereof.

The instructions 524 may further be transmitted or received over a communications network 526 using a transmission medium via the network interface device 520 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi, LTE, and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e,g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within, a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method for providing country-specific recommendations for selling an item, the method comprising:
detecting, by one or more computer processors, the listing of an item that is being listed for sale by a seller in a first country;
responsive to the detecting, determining information to be added to the listing in respect of a possible sale of the item in a second country; and
informing the seller of the determined information.

2. The method of claim 1 wherein the determined information is determined using a data analytics method that works on one or more historical data logs to mine information relating to factors that may aid or improve sale of the item in the second country.

3. The method of claim 1 wherein the determined information is determined using a data analytics method that works on one or more historical data logs to mine information that indicates that it is attractive to list the item for sale in the second country.

4. The method of claim I wherein the determined information includes of one of purchasers in the second country generally give a high feedback scores than purchasers in the first country, items arrive to purchaser in the second country from the first country within a desirable number of days, better wording of the listing that will help sell the item in the second country, a second country where the item is selling well, shipping issues for the second country, and a second country where the item will fetch a higher price than in the first country.

5. The method of claim 1 wherein the determined information is information that indicates that it is attractive to list the item for sale in the second country.

6. The method of claim 1, the method further including detecting that the seller has added the determined information to the item listing.

7. The method of claim 6, the method further including detecting a signal that indicates that the item is to be listed for sale in the second country and, responsive to detecting the signal, carrying out a process for listing the item for sale in the second country.

8. One or more computer-readable hardware storage devices having embedded therein a set of instructions which, when executed by one or more processors of a computer, causes the computer to execute operations comprising:
detecting, by one or more computer processors, the listing of an item that is being listed for sale by a seller in a first country;
responsive to the detecting, determining information to be added to the listing in respect of a possible sale of the item in a second country; and
informing the seller of the determined information.

9. The one or more computer-readable hardware storage device of claim 8 wherein the determined information is determined using a data analytics method that works on one or more historical data logs to mine information relating to factors that may aid or improve sale of the item in the second country.

10. The one or more computer-readable hardware storage device of claim 8 wherein the determined information is determined using a data analytics method that works on one or more historical data logs to mine information that indicates that it is attractive to list the item for sale in the second country.

11. The one or more computer-readable hardware storage device of claim 8 wherein the determined information includes of one of purchasers in the second country generally give a high feedback scores than purchasers in the first country, items arrive to purchaser in the second country from the first country within a desirable number of days, better wording of the listing that will help sell the item in the second country, a second country where the item is selling well, shipping issues for the second country, and a second country where the item will fetch a higher price than in the first country.

12. The one or more computer-readable hardware storage device of claim 8 wherein the determined information is information that indicates that it is attractive to list the item for sale in the second country.

13. The one or more computer-readable hardware storage device of claim 8, the operations further comprising detecting that the seller has added the determined information to the item listing.

14. The one or more computer-readable hardware storage device of claim 13, the operations further comprising detecting a signal that indicates that the item is to be listed for sale in the second country and, responsive to detecting the signal, carrying out a process for listing the item for sale in the second country.

15. A system for providing country-specific recommendations for selling an item, the system comprising:
one or more computer processors configured to
detect, by one or more computer processors, the listing of an item that is being listed for sale by a seller in a first country;
responsive to the detecting, determine information to be added to the listing in respect of a possible sale of the item in a second country; and
inform the seller of the determined information.

16. The system of claim 15 wherein the determined information is determined using a data analytics method that works on one or more historical data logs to mine information relating to factors that may aid or improve sale of the item in the second country.

17. The system of claim 15 wherein the determined information is determined using a data analytics method that works on one or more historical data logs to mine infouiiation that indicates that it is attractive to list the item for sale in the second country.

18. The system of claim 15 wherein the determined information includes of on.e of purchasers in the second country generally give a high feedback scores than purchasers in the first country, items arrive to purchaser in the second country from the first country within a desirable number of days, better wording of the listing that will help sell the item in the second country, a second country where the item is selling well, shipping issues for the second country, and a second country where the item will fetch a higher price than in the first country.

19. The system of claim 15 wherein the determined information is information that indicates that it is attractive to list the item for sale in the second country.

20. The system of claim 15, the one or more computer processors further configured to detect that the seller has added the determined information to the item listing, and to detect a signal that indicates that the item is to be listed for sale in the second country and, responsive to detecting the signal, to carry out a process for listing the item for sale in the second country.
